(19) United States
(12) Patent Application Publication
(10) Pub. No.: US 2011/0074829 A1
(43) Pub. Date: Mar. 31, 2011

(54) MOBILE COMMUNICATION TERMINAL INCLUDING TOUCH INTERFACE AND METHOD THEREOF

(75) Inventor: Younhee LEE, Seoul (KR)

(73) Assignee: PANTECH CO., LTD., Seoul (KR)

(21) Appl. No.: 12/776,157

(22) Filed: May 7, 2010

(30) Foreign Application Priority Data
Sep. 30, 2009 (KR) 10-2009-0093464

(51) Int. Cl. G09G 5/00

(52) U.S. Cl. 345/661

(57) ABSTRACT

A mobile communication terminal includes a touch unit to receive a first touch and to generate a first touch signal according to the received first touch, a coordinate computation unit to receive the first touch signal from the touch unit to compute first touch position coordinates of the first touch, a region enlargement unit to define an original region in accordance with an enlargement condition according to the first touch position coordinates and to enlarge the original region to generate an enlargement region, a coordinate mapping unit to generate second coordinates of the enlargement region and to map first coordinates of the original region with the second coordinates of the enlargement region, and a control unit to perform a command on the first coordinates of the original region. A method for the mobile communication terminal includes displaying the enlargement region on a display of the mobile communication terminal.

### CROSS-REFERENCE TO RELATED APPLICATION

This application claims priority from and the benefit of Korean Patent Application No. 10-2009-0093464, filed on Sep. 30, 2009, which is hereby incorporated by reference for all purposes as if fully set forth herein.

### BACKGROUND

1. Field

Exemplary embodiments of the present invention relate to a mobile communication terminal including a touch interface and a method for the touch interface.

2. Discussion of the Background

In general, a touch screen or a touch panel may be one of several input devices is that are used as a user interface of electronic equipment. A user may operate the electronic equipment by directly contacting a screen using a finger or a pen without using supplementary peripheral devices, such as a keyboard, a mouse, and the like.

A mobile communication terminal using a touch interface may enlarge a displayed portion in a region in which a touch is detected. However, a region separately designated by a user may be enlarged and displayed. Also, the enlargement function may be provided only to specific applications or content.

### SUMMARY

Exemplary embodiments of the present invention provide a mobile communication terminal including a touch interface and a method therefor in which a region is enlarged in accordance with a location where a touch is inputted in the mobile communication terminal including a touch screen.

Additional features of the invention will be set forth in the description which follows, and in part will be apparent from the description, or may be learned by practice of the invention.

According to an exemplary embodiment of the present invention, there is provided a mobile communication terminal including a touch interface, including: a touch unit to receive a first touch and to generate a first touch signal; a coordinate computation unit to receive the first touch signal from the touch unit to compute first touch position coordinates of the first touch; a region enlargement unit to define an original region having first coordinates in accordance with an enlargement condition according to the first touch position coordinates, and to generate an enlargement region; a coordinate mapping unit to generate second coordinates of is the enlargement region, and to map the first coordinates of the original region with the second coordinates of the enlargement region; and a control unit to perform a command on the first coordinates of the original region.

According to an exemplary embodiment of the present invention, there is provided a method for a touch interface of a mobile communication terminal, the method including: generating a first touch signal if a first touch is received; computing first touch position coordinates using the first touch signal; defining an original region having first coordinates in accordance with an enlargement condition using the first touch position coordinates, enlarging the original region to generate an enlargement region; generating second coordinates of the enlargement region, mapping the first coordinates of the original region with the second coordinates of the enlargement region; and displaying the enlargement region on a display of the mobile communication terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a mobile communication is terminal according to an exemplary embodiment of the present invention.

FIG. 2 is a flowchart illustrating a method for a touch interface of a mobile communication terminal according to an exemplary embodiment of the present invention.

FIG. 3 is a diagram illustrating a method for a touch interface according to an exemplary embodiment of the present invention.

FIG. 4 is a diagram illustrating a method for a touch interface according to an exemplary embodiment of the present invention.

FIG. 5 illustrates an example of a touch interface according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” is includes any and all combinations of one or more of the associated listed items.

The terminology used herein is for the purpose of describing particular embodiments only and is not intended to be limiting of example embodiments. As used herein, the singular forms “a”, “an”, and “the” are intended to include the plural forms as well, unless the context clearly indicates otherwise. It will be further understood that the terms “comprises”, “comprising,”, “includes”, and/or “including”, when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings.

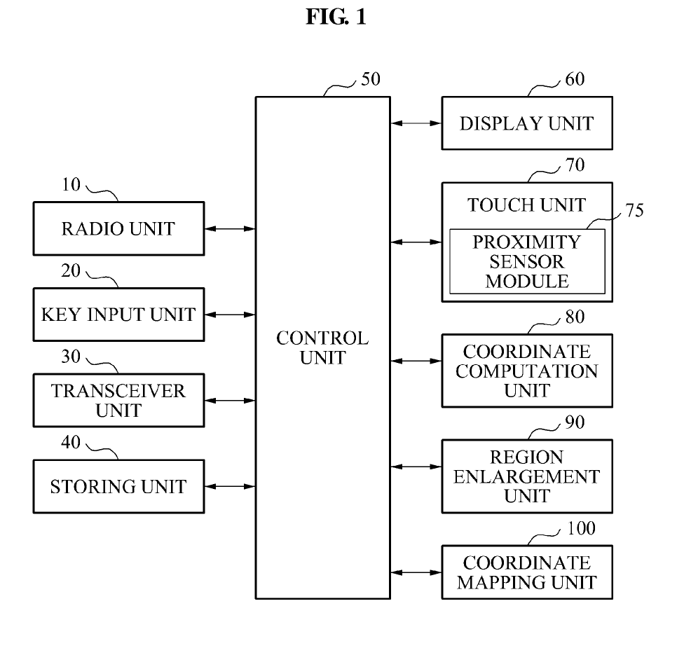

FIG. 1 is a diagram illustrating a configuration of a mobile communication terminal according to an exemplary embodiment of the present invention. Referring to FIG. 1, the mobile communication terminal may include a touch unit 70, a coordinate computation unit 80, a region enlargement unit 90, and a coordinate mapping unit 100. The touch unit 70, the coordinate computation unit 80, the region enlargement unit 90, and the coordinate mapping unit 100 may implement a method for a touch interface according to an exemplary embodiment of the present invention.

In FIG. 1, the touch unit 70, the coordinate computation unit 80, the region enlargement unit 90, and the coordinate mapping unit 100 are illustrated as separate blocks merely to more definitely distinguish the mobile communication terminal in which the method for the touch interface is implemented. Further, operations performed by the coordinate computation unit 80, the region enlargement unit 90, and the coordinate mapping unit 100 may is be performed by a control unit 50, and the touch unit 70 may be included in a display unit 60 of a mobile communication terminal as an input unit.

Referring to FIG. 1, the mobile communication terminal includes a radio unit 10, a key input unit 20, a transceiver unit 30, a storing unit 40, the control unit 50, a display unit 60, the touch unit 70, the coordinate computation unit 80, the region enlargement unit 90, and the coordinate mapping unit 100.

The radio unit 10 may process a radio frequency (RF) signal transmitted/received in a wireless manner. The radio unit 10 may convert image data or voice data into/from the RF signal to transmit/receive the RF signal.

The key input unit 20 may receive key inputs for operations of the mobile communication terminal, such as a video call request, a general call request, a data input, and the like. The key input unit 20 may include a button unit where a key input is performed.

The transceiver unit 30 may include a microphone and a speaker through which a voice call is performed.

The storing unit 40 may include a Read Only Memory (ROM), or a memory used for storing programs and data. The storing unit 40 may store a variety of data, messages, and the like, generated or received in the mobile communication terminal. The storing unit 40 may store commands that correspond to input signals of the key input unit 20.

The display unit 60 may display a variety of display data, messages, and the like, generated or received in the mobile communication terminal. The display unit 60 may provide a touch interface and display an enlargement region corresponding to an original region.

The control unit 50 may control the radio unit 10, the key input unit 20, the transceiver unit 30, the storing unit 40, the control unit 50, the display unit 60, the touch unit 70, is the coordinate computation unit 80, the region enlargement unit 90, and the coordinate mapping unit 100. The control unit 50 may include a digital signal processor, a micro processor, and the like.

Hereinafter, the touch unit 70, the coordinate computation unit 80, the region enlargement unit 90, and the coordinate mapping unit 100 according to an exemplary embodiment of the present invention will be further described.

The touch unit 70 may include a touch screen or a touch panel and may be an input unit where a touch is received to generate a touch signal. The mobile communication terminal according to an exemplary embodiment of the present invention may receive input through the key input unit 20 and/or the touch unit 70. Also, the touch unit 70 may be implemented on the display unit 60.

The touch unit 70 according to an exemplary embodiment of the present invention may generate a first touch signal with respect to a first touch inputted to the touch unit 70. The touch unit 70 may sense the touch by a sensor disposed in accordance with coordinates that are designated on a screen. That is, the mobile communication terminal may compute touch position coordinates of the touch by sensing the touch.

The touch unit 70 may include a proximity sensor module 75. The proximity sensor module 75 may determine a proximity of a touch device in accordance with a proximity determination criterion to thereby generate the first touch signal. The proximity determination criterion may be designated by a user on the mobile communication terminal.

Here, the proximity determination criterion may be at least one of a distance range where the touch device approaches, and a period during which the distance range is maintained after the touch device approaches the distance range. The touch device may be a device capable is of touching the touch unit 10 and may be a touch tool, such as a finger of a user, a touch pen, and the like.

For example, the proximity determination criterion may be designated such that the touch device is maintained within a proximity distance of 2 mm for three seconds or more. Here, if the finger of the user is maintained within 2 mm for three seconds or more, the proximity sensor module 75 may generate a touch signal.

The mobile communication terminal according to an exemplary embodiment of the present invention may acquire first touch position coordinates that indicate where the first touch signal is generated, and the mobile communication terminal may display an enlargement region with respect to an original region on a currently displayed screen using the first touch position coordinates. This will be further described with reference to the coordinate computation unit 80, the region enlargement unit 90, and the coordinate mapping unit 100.

The touch unit 70 may receive a second touch on the displayed enlargement region or the proximity sensor module 75 of the touch unit may detect a touch device satisfying a proximity determination criterion. The touch unit 70 or the proximity sensor module 75 may generate a second touch signal with respect to the second touch. The coordinate computation unit 80 may receive the first touch signal from the touch unit 70 to compute the first touch position coordinates. Also, the coordinate computation unit 80 may receive the second touch signal from the touch unit 70 to compute second touch position coordinates using coordinates of the enlargement region.

The mobile communication terminal according to an exemplary embodiment of the present invention may generate the coordinates of the enlargement region after generating the enlargement region.

The region enlargement unit 90 may generate the enlargement region obtained by enlarging an original region defined with respect to the first touch position coordinates in accordance with an enlargement condition. Here, the enlargement condition may be designated by in advance, and the enlargement condition may include at least one of a size or shape of the original region and an enlargement ratio of the enlargement region.

For example, the region enlargement unit 90 may generate the enlargement region obtained by longitudinally and laterally doubling a rectangular shaped-original region with respect to the first touch position coordinates. For example, the rectangular shaped-original region may be a 5 mm square and may be centered at the first touch position coordinates. The region enlargement unit 90 may generate the enlargement region by doubling lengths of sides or an area of the rectangular shaped-original region.

Also, the region enlargement unit 90 may generate a pointer to be an interface for a user. That is, the region enlargement unit 90 may generate the pointer positioned at the first touch position coordinates, thereby providing an interface to indicate a position touched by the user. The pointer may be positioned in the second touch position coordinates with respect to the second touch position coordinates.

The coordinate mapping unit 100 may generate the coordinates of the enlargement region generated by the region enlargement unit 90 and may map coordinates of the original region with the coordinates of the enlargement region. The original region may be a region corresponding to the first touch position coordinates computed according to the first touch. The coordinate mapping unit 100 may map the coordinates of the original region with the coordinates of the enlargement region.

Also, the coordinate mapping unit 100 may map the coordinates of the is enlargement region with the coordinates of the original region to thereby store the mapped coordinates in a mapping table. The coordinate mapping unit 100 may store the mapping table in the storing unit 40 or may separately store the mapping table in the coordinate mapping unit 100.

If the second touch is generated in the enlargement region, the coordinate mapping unit 100 may receive the second touch position coordinates from the coordinate computation unit 80, and may transmit to the control unit 50 the coordinates of the original region corresponding to the second touch position coordinates. Further, the control unit 50 may perform a command on the coordinates of the original region corresponding to the second touch position coordinates in response to the second touch received at the second touch position coordinates of the enlargement region.

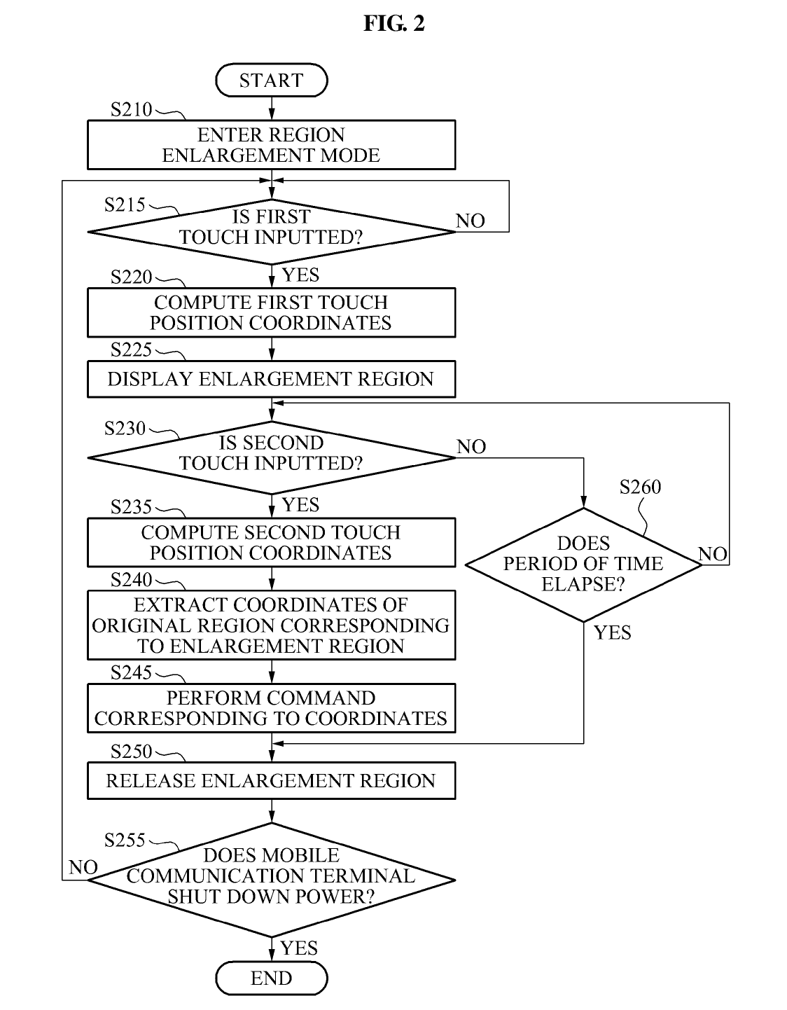

FIG. 2 is a flowchart illustrating a method for a touch interface of a mobile communication terminal according to an exemplary embodiment of the present invention. Referring to FIG. 2, in operation S210, the mobile communication terminal may enter a region enlargement mode. The region enlargement mode may be a mode designated to provide the touch interface according to an exemplary embodiment of the present invention. That is, the region enlargement mode may be designated or released in accordance with a setting and/or may be implemented by a manufacturer of the mobile communication terminal.

In operation S215, the mobile communication terminal may determine whether a first touch is inputted. The mobile communication terminal may recognize a touch initially sensed from a user as the first touch. That is, the mobile communication terminal may enter a wait state when a specific period of time elapses after processing a currently inputted touch. Accordingly, the mobile communication terminal may recognize a touch inputted in the wait state as the first touch.

In operation S220, if the first touch is inputted according to the determined result of operation S215, the mobile communication terminal may compute first touch position coordinates. The mobile communication terminal may sense a touch using a touch sensor disposed in accordance with coordinates on a screen. Thus, the mobile communication terminal may receive the first touch to generate a first touch signal and may compute the first touch position coordinates.

The mobile communication terminal according to an exemplary embodiment of the present invention may include a proximity sensor module 75 in the touch unit 70. The proximity sensor module 75 may determine proximity of a touch device in accordance with a proximity determination criterion. The proximity sensor module 75 may recognize a proximity of the touch device as the first touch to thereby generate the first touch signal. The proximity determination criterion may be at least one of a distance range into which the touch device approaches, and a period during which the touch device is maintained within the distance range after the touch device enters the distance range. The touch device may be a device capable of touching the touch unit and may be a touch tool, such as a finger of a user, a touch pen, and the like.

In operation S225, the mobile communication terminal may generate an enlargement region using the computed first touch position coordinates and may display the generated enlargement region. The mobile communication terminal may generate a pointer positioned at the first touch position coordinates. Here, the pointer may be an interface capable of recognizing a position touched by a user, and may be moved depending on an inputted touch.

The enlargement region may be obtained by enlarging an original region in accordance with an enlargement condition. The original region may be defined in accordance with the enlargement condition. Further, the enlargement condition may be designated by a user in advance and may include at least one of a size or shape of the original region and an enlargement ratio of the enlargement region. That is, the mobile communication terminal may define the original region with respect to the first touch position coordinates in accordance with the enlargement condition and may generate the enlargement region obtained by enlarging the defined original region.

Also, the mobile communication terminal may generate coordinates of the generated enlargement region and may map coordinates of the original region with the coordinates of the enlargement region to thereby store the mapped coordinates. The mobile communication terminal may map the coordinates of the original region with the coordinates of the enlargement region to store the mapped coordinates in a mapping table.

In operation S230, the mobile communication terminal may determine whether a second touch is inputted. The mobile communication terminal may generate the enlargement region, display the generated enlargement region, and determine whether the second touch is sensed in the enlargement region.

In operation S260, if the second touch is not inputted according to the determined result of operation S230, the mobile communication terminal may determine whether a specific period of time elapses and may advance to operation S250 if the specific period of time elapses.

In operation S235, if the second touch is inputted according to the determined result of operation S230, the mobile communication terminal may compute second touch position coordinates in the enlargement region.

In operation S240, the mobile communication terminal may compute or extract coordinates of the original region corresponding to the enlargement region. That is, the mobile is communication terminal may compute the coordinates of the original region that are mapped in the second touch position coordinates computed in the enlargement region.

In operation S245, the mobile communication terminal may perform a command on corresponding coordinates in the enlargement region using the computed coordinates of the original region.

In operation S250, the mobile communication terminal may release the enlargement region.

In operation S255, the mobile communication terminal may determine whether to shut down power of the mobile communication terminal.

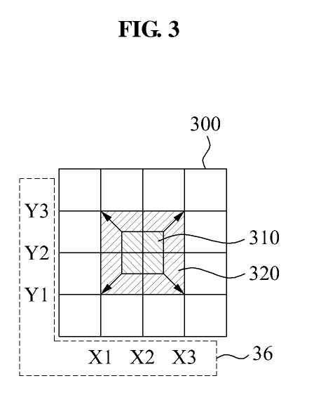

FIG. 3 is a diagram illustrating a method for a touch interface according to an exemplary embodiment of the present invention. More specifically, FIG. 3 is a diagram illustrating a screen 300 of the mobile communication terminal according to an exemplary embodiment of the present invention.

Referring to FIG. 3, in the screen of the mobile communication terminal, respective coordinates 36 of an X-axis and a Y-axis may be designated. An enlargement region 320 may be obtained by longitudinally and laterally enlarging an original region 310 according to an enlargement ratio.

If first touch position coordinates are (X2, Y2), the original region 310 may be defined to have a size and shape with respect to the first touch position coordinates. Also, the enlargement region 320 may be generated by longitudinally and laterally enlarging the original region 310 by the enlargement ratio.

For example, the mobile communication terminal may receive a first touch on the screen 300, compute the first touch position coordinates (X2, Y2), and define the original region 310 with respect to the first touch position coordinates (X2, Y2). The mobile communication terminal may longitudinally and laterally enlarge the defined original region 310 by the enlargement ratio to generate the enlargement region 320.

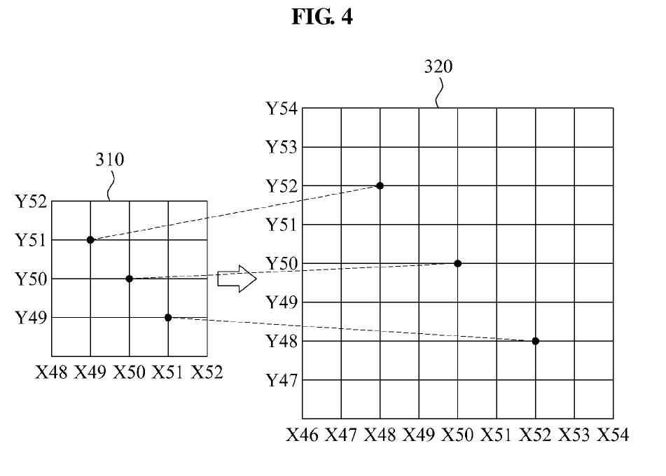

FIG. 4 is a diagram illustrating a method for a touch interface according to an exemplary embodiment of the present invention. More specifically, FIG. 4 is a diagram illustrating a mapping relation between the original region 310 and the enlargement region 320.

Referring to FIG. 4, the mobile communication terminal may generate the enlargement region 320 corresponding to the original region 310 and may generate coordinates of the enlargement region 320. The mobile communication terminal may map respective coordinates of the original region 310 and respective coordinates of the enlargement region 320 and nay store the mapped coordinates. For example, as illustrated in FIG. 4, the mobile communication terminal may allow the respective coordinates of the original region 310 and the respective coordinates of the enlargement region 320 to mutually correspond to each other and may store the mutually corresponding coordinates in a mapping table. In this instance, dotted lines of FIG. 4 may be obtained by allowing the respective coordinates of the original region 310 and the respective coordinates of the enlargement region 320 to mutually correspond to each other.

Here, the mapping table may be shown as in the following Table 1.

TABLE 1

| Coordinates | |
|---|---|
| of original region 310 | Coordinates of enlargement region 320 |
| X49, Y51 | X48, Y52 |
| X50, Y51 | X50, Y52 |
| X51, Y51 | X52, Y52 |
| X49, Y50 | X48, Y50 |
| X50, Y50 | X50, Y50 |
| X51, Y50 | X52, Y50 |
| X49, Y49 | X48, Y48 |
| X50, Y49 | X50, Y48 |
| X51, Y49 | X52, Y48 |

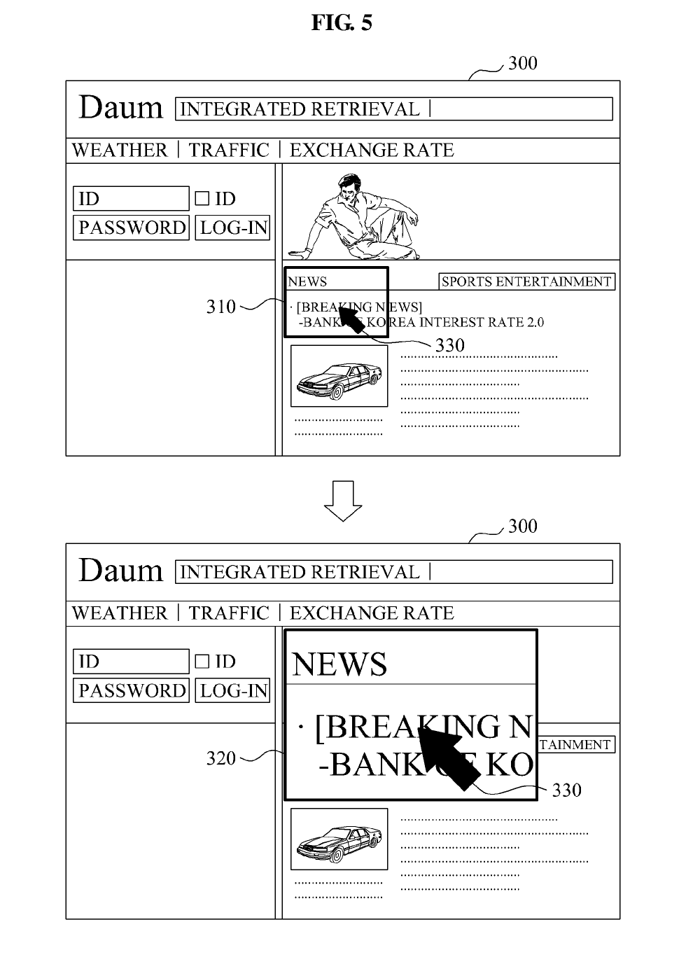

FIG. 5 illustrates an example of a touch interface according to an exemplary embodiment of the present invention. Referring to FIG. 5, the mobile communication terminal may output a webpage on a screen 300. Here, the mobile communication terminal may wirelessly download the webpage from the Internet.

If a touch is received, the mobile communication terminal may display a pointer 330 at a position where the touch is performed. The mobile communication terminal may define the original region 310 in accordance with an enlargement condition.

The mobile communication terminal may generate the enlargement region 320 obtained by enlarging the original region 310 by an enlargement ratio in accordance with the enlargement condition and may display the generated enlargement region 320. In this instance, the pointer 330 may be positioned at first touch position coordinates.

If, for example, a desired link of the webpage is clicked using the pointer 330 in the enlargement region, the mobile communication terminal may receive a second touch. The mobile communication terminal may control the pointer 330 to prevent the pointer 330 from being deviated from the enlargement region 320.

The touch interface according to an exemplary embodiment of the present invention may be provided in accordance with an application outputted on the screen 300 of the is mobile communication terminal. For example, if the application outputted on the screen 300 is a web browser, the mobile communication terminal may enlarge only a specific region where a finger of a user approaches to thereby click a link of a webpage displayed by the web browser.

Further, for example, if the application is an image viewer, the mobile communication terminal may enlarge only a specific region where the finger of the user approaches to thereby perform an image correction operation.

Also, for example, if the application is a music player, the mobile communication terminal may enlarge a progress bar if the finger of the user approaches the progress bar when playing music to thereby control a rewind function, a fast-forward function, and the like.

Moreover, for example, if the application is a menu tree, the mobile communication terminal may enlarge a specific menu if the finger of the user approaches to thereby select a menu.

And, for example, if the application is a list window, the mobile communication terminal may enlarge only a portion of a scroll bar where the finger of the user approaches to thereby perform a scrolling operation.

The method for the touch interface according to exemplary embodiments of the present invention may be recorded in computer-readable media including program commands to implement various operations embodied by a computer. The media may also include, alone or in combination with the program commands, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program commands, such as read-only memory (ROM), random access memory (RAM), flash memory, is and the like. Examples of program commands include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile communication terminal, comprising:
a touch unit to receive a first touch and to generate a first touch signal;
a coordinate computation unit to receive the first touch signal from the touch unit to compute first touch position coordinates of the first touch;
a region enlargement unit to define an original region having first coordinates in accordance with an enlargement condition according to the first touch position coordinates and to generate an enlargement region;
a coordinate mapping unit to generate second coordinates of the enlargement region and to map the first coordinates of the original region with the second coordinates of the enlargement region; and
a control unit to perform a command according to the first coordinates of the original region.

2. The mobile communication terminal of claim 1, wherein the touch unit receives a second touch in the enlargement region to generate a second touch signal, the coordinate computation unit receives the second touch signal from the touch unit to compute second touch position coordinates using the second coordinates of the enlargement region, and the control unit performs the command on the first coordinates of the original region corresponding to the second touch position coordinates.

3. The mobile communication terminal of claim 1, wherein the touch unit comprises a proximity sensor module to generate the first touch signal, and the proximity sensor module generates the first touch signal if a touch device approaches within a distance range of the touch unit.

4. The mobile communication terminal of claim 1, wherein the coordinate mapping unit maps the first coordinates of the original region with the second coordinates of the enlargement region to generate a mapping table.

5. The mobile communication terminal of claim 1, wherein the region enlargement unit generates a pointer at the first touch position coordinates, and the pointer is moved according to a second touch in the enlargement region.

6. The mobile communication terminal of claim 1, wherein the enlargement condition includes at least one of a size or a shape of the original region and an enlargement ratio of the enlargement region.

7. The mobile communication terminal of claim 1, wherein the touch unit includes a proximity sensor module to generate the first touch signal, and the proximity sensor module generates the first touch signal if a touch device approaches within a distance range of the touch unit and remains within the distance range for a period of time.

8. The mobile communication terminal of claim 7, wherein the distance range is 2 mm.

9. The mobile communication terminal of claim 7, wherein the period of time is 3 seconds.

10. The mobile communication terminal of claim 7, wherein the distance range and the period of time are adjustable.

11. A method for a touch interface of a mobile communication terminal, the method comprising:
generating a first touch signal if a first touch is received;
computing first touch position coordinates using the first touch signal;
defining an original region having first coordinates in accordance with an enlargement condition using the first touch position coordinates;
enlarging the original region to generate an enlargement region;
generating second coordinates of the enlargement region;
mapping the first coordinates of the original region with the second coordinates of the enlargement region; and
displaying the enlargement region on a display of the mobile communication terminal.

12. The method of claim 11, wherein, after the displaying of the enlargement region, the method further comprises:
generating a second touch signal if a second touch is received in the enlargement region;
computing second touch position coordinates in the enlargement region according to the second touch signal;
computing the first coordinates of the original region corresponding to the second touch position coordinates; and
performing a command on the first coordinates of the original region corresponding to the second touch position coordinates in the enlargement region.

13. The method of claim 11, wherein the generating of the first touch signal further comprises:
generating the first touch signal if a touch device approaches within a distance range of the mobile communication terminal.

14. The method of claim 11, wherein the generating of the first touch signal further comprises:
determining a proximity of a touch device with respect to the mobile communication terminal; and
generating the first touch signal if the proximity of the touch device is determined to be within a distance range of the mobile communication terminal.

15. The method of claim 11, wherein the generating of the first touch signal further comprises:
determining a proximity of a touch device with respect to the mobile communication terminal;
determining a period of time for which the proximity of the touch device is within a distance range of the mobile communication terminal; and
generating the first touch signal if the proximity of the touch device is determined to be within the distance range of the mobile communication terminal for a specific period of time.

16. The method of claim 11, the enlarging the original region further comprises:
enlarging the original region according to an enlargement condition to generate the enlargement region.

17. The method of claim 16, wherein the enlargement condition includes at least one of a size or a shape of the original region and an enlargement ratio of the enlargement region.

18. The method of claim 11, further comprising:
generating a pointer at the first touch position coordinates.

19. The method of claim 18, further comprising:
preventing the pointer from deviating from the enlargement region.

20. The method of claim 11, further comprising:
storing the mapped first coordinates and the mapped second coordinates.
